(19) United States
(12) Patent Application Publication
(10) Pub. No.: US 2012/0324454 A1
(43) Pub. Date: Dec. 20, 2012

(54) Control Flow Graph Driven Operating System

(75) Inventors: Alexander G. Gounares, Kirkland, WA (US); Charles D. Garrett, Woodinville, WA (US)

(73) Assignee: CONCURIX CORPORATION, Kirkland, WA (US)

(21) Appl. No.: 13/463,844

(22) Filed: May 4, 2012

(51) Int. Cl. G06F 9/46

(52) U.S. Cl. 718/100

(57) ABSTRACT

An operating system may be reconfigured during execution by adding new components to a control flow graph defining a system's executable flow. The operating system may use a control flow graph that defines executable elements and relationships between those elements. The operating system may traverse the control flow graph during execution to monitor execution flow and prepare executable elements for processing. By placing new components in memory then modifying the control flow graph, the operating system functionality may be updated or changed. In some embodiments, a lightweight version of an operating system may be deployed, then additional features or capabilities may be added.

### BACKGROUND

Control flow graphs are used in computer science to represent all of the paths a program may traverse during execution of the program. In a control flow graph, each mode may represent a block of code, and the edges of the graph represent possible jumps in the control flow. Control flow graphs are often used in static analyses of code, as well as various compiler optimizations.

### SUMMARY

An operating system may use a control flow graph to link various executable elements for both application and operating system functions. The applications and operating system be reconfigured during execution by adding new components to a control flow graph defining a system's executable flow. The operating system may traverse the control flow graph during execution to monitor execution flow and prepare executable elements for processing, as well as modify the systems functions by adding or removing elements. The operating system and application functionality may be updated or changed by replacing executable elements. In some embodiments, a lightweight version of an operating system may be deployed, then additional features or capabilities may be added.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system managed with control flow graphs.

FIG. 2 is a diagram illustration of an embodiment showing an example control flow graph.

FIG. 3 is a diagram illustration of an embodiment showing an example control flow graph an element being removed.

FIG. 4 is a flowchart illustration of an embodiment showing a method for managing execution using a control flow graph.

FIG. 5 is a flowchart illustration of an embodiment showing a method for adding an application to a system control flow graph.

FIG. 6 is a flowchart illustration of an embodiment showing a method for removing an executable element from a control flow graph.

### DETAILED DESCRIPTION

An operating system may use a control flow graph to manage the configuration of a computer system. The control flow graph may identify relationships between application components, operating system components, and other executable modules. The operating system may traverse the control flow graph to determine which elements are ready to execute, and may prepare downstream elements for execution.

The configuration of a computer system may be determined by identifying any applications that may execute and creating a control flow graph that identify relationships to operating system components. New applications may be executed by adding relationships within the control flow graph to executable elements in the application. Applications and the operating system may be extended by adding new elements to the control flow graph. Using the same techniques, executable elements may be replaced, allowing updates to be made on the fly.

In one use scenario, a lightweight operating system may be deployed to a device. The lightweight operating system may contain only those executable elements to perform a limited set of functions. The operating system may be extended as new applications may be added to the control flow graph, which may call specific operating system functions. If the operating system functions are not present in the control flow graph, the functions may be downloaded to the device and added to the control flow graph.

The operating system may use the control flow graph as a mechanism to identify work to perform and to schedule work payloads for a process scheduler. The control flow graph may represent all of the executable elements available on the device with relationships to other elements, input devices, data objects, or other items. The operating system may manage work payloads by identifying an input, interrupt, data object, or other item, traversing the control flow graph to find elements that consume the item, and causing the element to execute.

The control flow graph may enable an operating system or workload manager to make high level decisions about managing the operations of executable elements. The knowledge and management of relationships between the executable elements may enable various optimization scenarios, as well as performance monitoring and different mechanisms for managing executable code.

The control flow graph may identify chains of executable elements that have dependencies that flow from data received. These executable elements may be scheduled to minimize intervening processes so that the data may be processed quickly and efficiently.

The dependencies between executable elements may be explicit or implicit. Explicit dependencies may be defined within a programming language and identified by a programmer. In some cases, compilers or linkers may analyze source code to identify and explicitly link various executable elements. The explicit links between executable elements may be identified by messages that may be passed between two elements. In some cases, the messages may be addressed and passed from one element to another.

Some dependencies may be implied by how data may be shared between executable elements. A dependency may be identified, for example, when a consuming element uses a data object created by a creating element. The consuming element may be considered to have a dependency on the creating element even though no other relationship may be identified during normal compilation and linking

For the purposes of this specification and claims, the term “executable element” may define a set of instructions that may be executed by a processor. In a typical embodiment, an executable element may be machine level commands that may be sent to a processor. A single computer application may be made up of many executable elements. An executable element may also be referred to as a job, application, code chunk, or other term.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

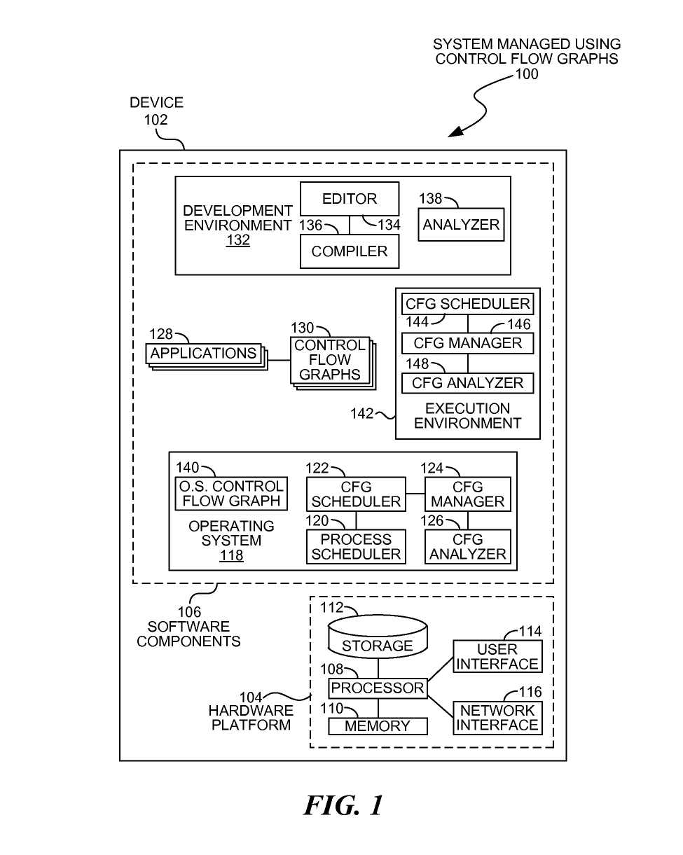

FIG. 1 is a diagram of an embodiment 100 showing a system that may operate a process scheduler based on input from a control flow graph. Embodiment 100 is a simplified example of the various software and hardware components that may be used an execution environment for applications and operating systems that may manage execution using control flow graphs.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

A control flow graph may define executable elements as nodes on the graph, and relationships between those elements as edges on the graph. In many embodiments, the edges may be directional and may show the execution flow or control flow of a group of related elements. The relationships may identify dependencies for a particular element. When those dependencies are fulfilled, the element may be executed.

An operating system or an executable environment may use a control flow graph to manage executable elements. Executable elements may be added to the control flow graph, which may then cause the executable environment to execute the element when its dependencies are met. Similarly, executable elements may be removed from the control flow graph, causing the system to not process those elements. Executable elements may also be replaced with different executable elements by adding a new element, then removing the old element.

The executable environment may be part of an operating system or may be a virtual machine or other executable environment. When the executable environment is separate from the operating system, such an environment may be a virtual machine component that may have just in time compiling, garbage collection, thread management, and other features.

When the operating system uses a control flow graph to manage execution, operating system components may be managed as individual executable elements. In such an embodiment, all or a large portion of the executable elements that may be executed may be included in a control flow graph. Such a control flow graph may include multiple applications as well as operating system functions, and may include relationships or dependencies between applications and between the applications and the operating system.

In some embodiments, the control flow graph may be comprised of several sub-graphs. In one such example, a high level control flow graph may include applications as individual elements with relationships to other applications or operating system functions, and each application or operating system function may also be represented by a sub-graph that includes smaller executable elements and their relationships. Some embodiments may have additional sub-graphs that may further refine executable elements.

The control flow graph may be used by a control flow graph scheduler to feed executable elements to a process scheduler. A process scheduler may be an operating system function that schedules executable code on a processor. In many computer systems, a process scheduler may create the illusion of executing several processes concurrently by time slicing or allocating a computing resource to different processes at different time intervals.

The process scheduler may have a control flow graph scheduler that may analyze a control flow graph to identify functional elements to add to a queue for the process scheduler.

The process scheduler may be known as a CPU scheduler and may determine which of the ready, in-memory processes may be executed following a clock interrupt, I/O interrupt, operating system call, or other form of signal. In some embodiments, the process scheduler may be preemptive, which may allow the process scheduler to forcibly remove executing elements from a processor when the processor may be allocated to another process. In some embodiments, the process scheduler may be non-preemptive, which may be known as voluntary or cooperative process scheduler, where the process scheduler may be unable to force executing elements off of a processor.

The device 102 is illustrated having hardware components 104 and software components 106. The device 102 as illustrated represents a conventional computing device, although other embodiments may have different configurations, architectures, or components.

In many embodiments, the device 102 may be a server computer. In some embodiments, the device 102 may still also be a desktop computer, laptop computer, netbook computer, tablet or slate computer, wireless handset, cellular telephone, game console or any other type of computing device.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

The operating system 118 may include a process scheduler 120. The process scheduler 120 may manage the executable elements at a processor level, and may perform time slicing or other functions that schedule operations on one or more processors. In multi-processor systems, each processor may have a process scheduler. In some such systems, several process schedulers may manage multiple processors.

A control flow graph scheduler 122 may examine a control flow graph to identify which executable elements are going to be executed next, then feeds the process scheduler 120 with the appropriate elements. The control flow graph scheduler 122 may receive a control flow graph that contains all of the executable elements that make up the code executing on the system 102. Such a control flow graph may include executable elements from multiple applications as well as operating system functions.

The control flow graph scheduler 122 may receive inputs from various sources, which may be interrupts from input devices, data created by executing elements, or other sources. When the inputs are received, the control flow graph scheduler 122 may traverse the control flow graph to identify those executable elements that may be waiting for an input. Those executable elements may be passed to the process scheduler 120 to be executed.

A control flow graph manager 124 may add and remove elements from the control flow graph. When elements are added, those elements may be executed once the conditions for those elements have been satisfied.

For example, an application may be added to the control flow graph, and one of the executable elements may be waiting for a user input, which may be an input from a pointing device within a graphical user interface. When the input may be received, the control flow graph scheduler 122 may identify the executable element and cause the process scheduler 120 to begin executing the application.

The control flow graph manager 124 may be capable of removing an executable element or group of executable elements from the control flow graph. In such an operation, the control flow graph manager 124 may remove a relationship or dependency for an executable element. Once the executable element has completed any processing that may be underway, the element may be removed from the control flow graph.

The control flow graph manager 124 may be capable or replacing an old executable element with a new executable element. In such an operation, the new element may be added and relationships established to the new element. Relationships to the old element may be severed and the old element may be removed. Such an operation allows software on an executing system to be upgraded and changed while the system is in full operation.

Some embodiments may have a control flow graph analyzer 126. The control flow graph analyzer 126 may analyze any new application or function to create a control flow graph. The analysis may identify executable elements within the application or function, as well as dependencies or inputs to those executable elements. In some cases, the control flow graph analyzer 126 may receive both executable code and a semantic description of the code to perform the control flow graph analysis. The semantic description may be source code, intermediate code, decompiled code, debugging symbols, or other descriptions.

The operating system 118 may execute various applications 128, some of which may have predefined control flow graphs 130. The predefined control flow graphs 130 may be created at compilation time or some other time prior to execution. When an application 128 may be executed, the corresponding control flow graph 130 may be transmitted to the control flow graph manager 124, which may add the application's control flow graph 130 to the system's control flow graph, which may then cause the application to be executed.

In cases where an application 128 may not have a predefined control flow graph 130, a control flow graph analyzer 126 may create a control flow graph for the application.

A development environment 132 may be a set of tools that a programmer may use to create the applications 128. In some cases, the development environment 132 may also create control flow graphs 130 for the applications 128.

The development environment 132 may have an editor 134 and compiler 136. In some cases, the compiler 136 may create a control flow graph 130 during compilation. In other cases, a separate analyzer 138 may create a control flow graph. The analyzer 138 may use the compiled code, which may be machine code or intermediate code, to create a control flow graph. In some embodiments, the analyzer 138 may create a control flow graph using higher level semantic information such as debugger symbols or source code.

In some embodiments, an execution environment 142 may manage one or more applications with a control flow graph scheduler 144. A control flow graph manager 146 may add, remove, and modify applications by adding or removing elements to a control flow graph. In some embodiments, a control flow graph analyzer 148 may create control flow graphs for applications.

The execution environment 142 may be a virtual machine or other managed environment that may include just in time compilers, garbage collection or other memory management tools, and other runtime management functions.

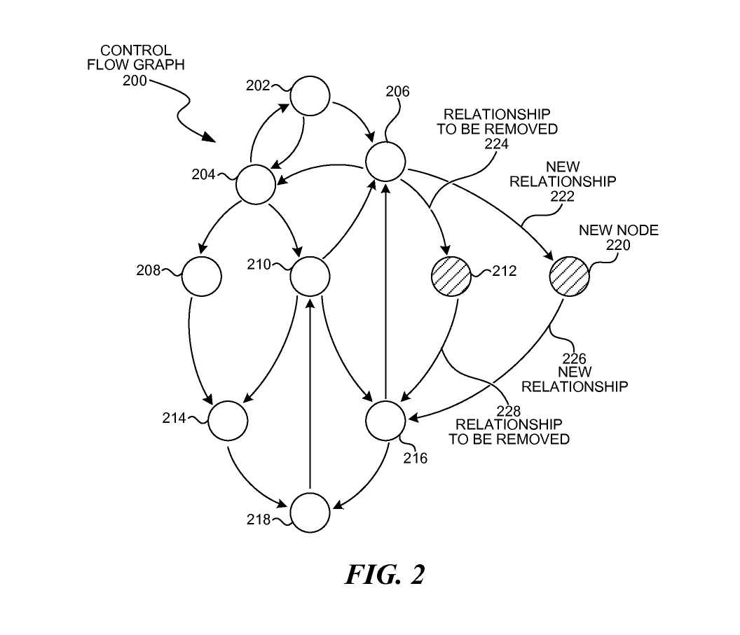

FIG. 2 is a diagram illustration of an embodiment 200 showing an example embodiment of a control flow graph. Embodiments 200 and 300 illustrate how a control flow graph may be changed by adding and removing elements.

The control flow graph contains elements 202 through 218 and relationships between the elements. Element 220 may be a new node that may replace node 212.

When adding a new node 220, a new upstream relationship 220 may be created from element 206 to node 220, and the relationship 224 between node 202 and node 212 may be removed. When the relationship 224 is removed, the flow from node 206 may divert to the new node 220.

The new node 220 may also have a downstream relationship 226 may be created to link node 220 with node 216.

In some cases, node 212 may still be processing, even though the relationship 224 may have been removed. In such a case, the node 212 may finish processing before relationship 228 from node 212 to node 216 may be removed.

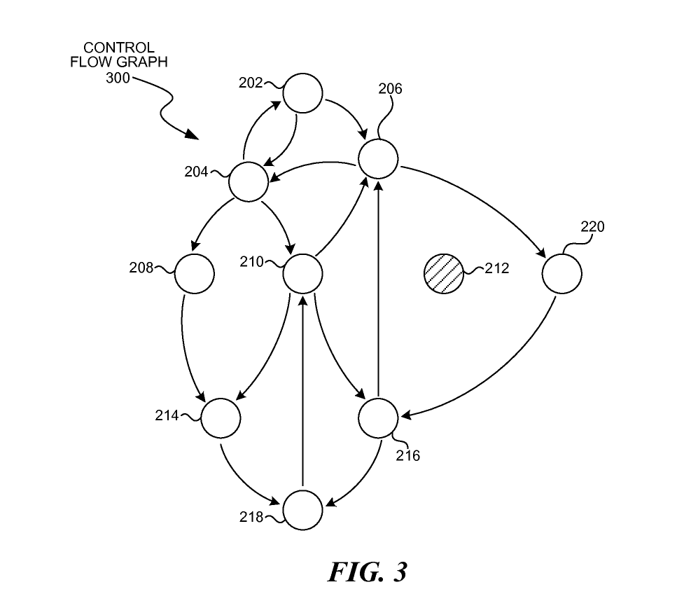

FIG. 3 is a diagram illustration of an embodiment 300 showing the example embodiment 200 after the relationships to node 212 have been removed. Embodiment 300 illustrates the flow of operations from node 206 to node 220 and then to node 216. Node 212 may have been removed from the flow and may now be discarded.

Embodiments 200 and 300 illustrate how node 220 may be added to the control flow graph. In the addition process, a new node may be added to the graph by creating new upstream relationships that supply information or other objects to the new node, and by creating new downstream relationships that consume information or other objects created by the new node.

Existing elements may be removed from a control flow graph by removing upstream and downstream relationships. In some cases, the element being removed may be permitted to finish any processing prior to removing downstream relationships. In other cases, the element may be halted from any ongoing processing and all relationships removed.

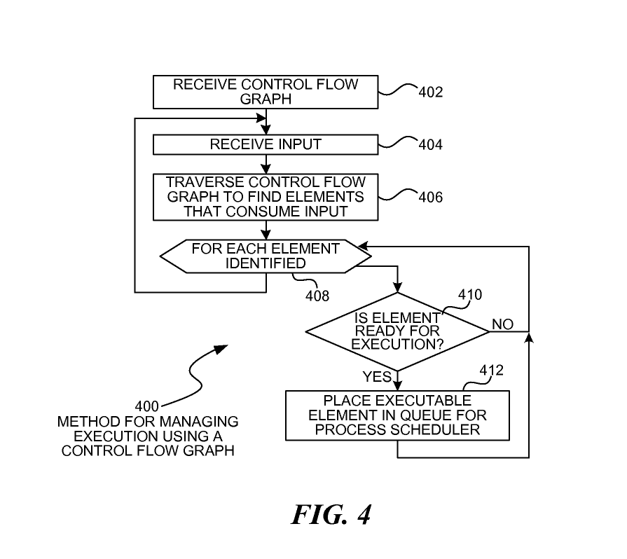

FIG. 4 is a flowchart illustration of an embodiment 400 showing a method for managing execution using a control flow graph. Embodiment 400 illustrates the operations of a control flow graph scheduler, such as the control flow graph schedulers 122 or 144 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is a simplified example of how a control flow graph scheduler may handle input and identify executable elements to pass to a process scheduler. The control flow graph scheduler may manage execution by traversing the control flow graph to find executable elements that are ready for execution. Such elements are those that have all of the input dependencies satisfied.

The input dependencies may be inputs received from an outside source, such as data received from a network interface, input received from a user input device such as a keyboard or mouse, data received from a disk drive, input from a sensor, or other input.

In many cases, the input dependencies may be data items that may come from other executable elements. Such dependencies may be defined in message passing interfaces or other dependencies.

The control flow graph may be received in block 402, and the input may be received in block 404.

The control flow graph may be traversed in block 406 to find all of the elements that may consume the input. The elements may be analyzed in block 408.

For each element in block 408, if the element is not ready for execution in block 410, the element may be left alone while the process returns to block 408. If the element is ready for execution in block 410, the element may be placed in a queue for a process scheduler in block 412.

The operations of embodiment 400 may represent the general operations of a control flow graph scheduler, which may control all of the operations of a computer system using a control flow graph.

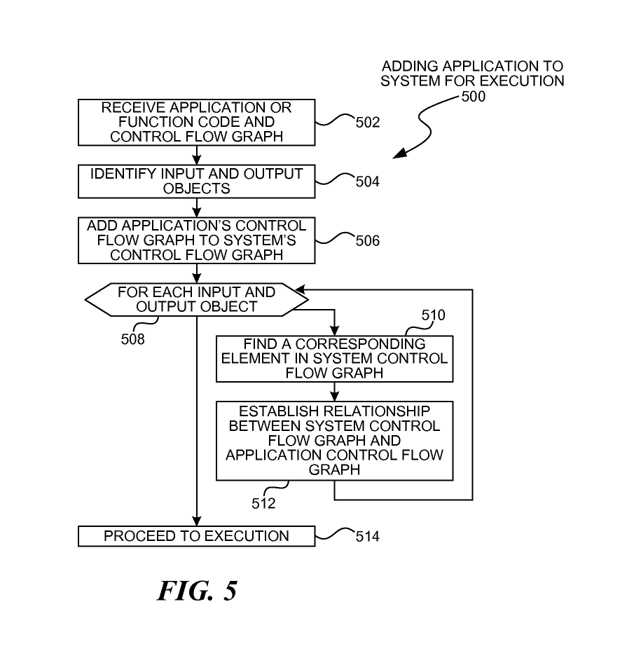

FIG. 5 is a flowchart illustration of an embodiment 500 showing a method for adding elements to a control flow graph for execution. Embodiment 500 illustrates the operations of a control flow graph manager, such as the control flow graph manager 124 or 146 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 may illustrate one method by which elements may be added to a control flow graph. Once the elements are added to the control flow graph, a control flow graph scheduler may cause the elements to be executed once the conditions for those elements are satisfied.

A control flow graph for an application, function, or other executable may be received in block 502. This control flow graph may define only the executable elements for the application or function and the relationships between those elements. This control graph may also be referred to as an application control flow graph. The input and output objects for the application control flow graph may be identified in block 504.

The application control flow graph elements may be added to the system control flow graph in block 506.

Each input and output element identified in block 504 may be analyzed in block 508. For each input and output element in block 508, a corresponding element in the system control flow graph may be identified in block 510. A relationship may be established between the corresponding element in the system control flow graph and the element in the application control flow graph.

In many cases, the input and output elements in an application control flow graph may map to operating system functions or services. The relationships between the application elements and operating system elements may link the application into the operating system.

Once all of the relationships are established, the system control flow graph may proceed to execution in block 514.

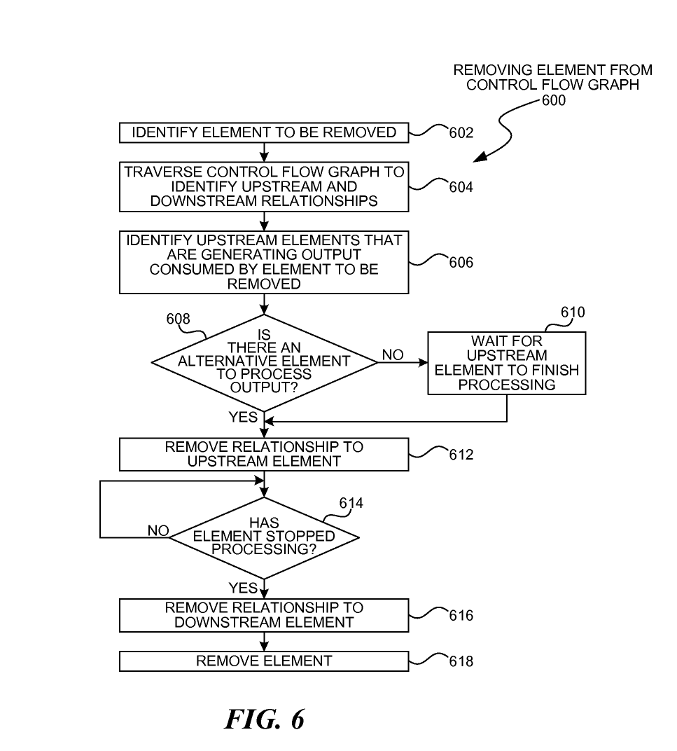

FIG. 6 is a flowchart illustration of an embodiment 600 showing a method for removing elements from a control flow graph where the elements in the control flow graph may be executing. Embodiment 600 illustrates the operations of a control flow graph manager, such as the control flow graph manager 124 or 146 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 illustrates a controlled method for removing elements from a control flow graph. Embodiment 600 may be used in cases where the control flow graph is actively being used to schedule elements on a running system.

In block 602, an element to be removed from the system control flow graph may be identified.

The control flow graph may be traversed in block 604 to identify both upstream and downstream relationships from the old element that will be removed.

In block 606, upstream elements that are currently generating output consumed by the element to be removed are identified. In some conditions, removing the identified element too soon may interrupt or destroy a process that may consume the output from upstream elements.

If there is no alternative element in block 608 that may process the output of the upstream elements, the process may wait in block 610 until the upstream elements have finished processing before proceeding to block 612. If there is an alternative in block 608, the process may go to block 612, where the relationship to the upstream element may be removed.

In block 614, the process may loop until the element has stopped processing. Once the element has stopped processing in block 614, all relationships to downstream elements may be removed in block 616. At this point, the element has no relationships within the control flow graph and the element itself may be removed in block 618.

Embodiment 500 may attempt to remove an element by waiting until the processes that use the element have finished execution. In some cases, another embodiment may remove an element by removing the relationships to that element regardless of whether the removal may jeopardize a process that may flow through the element to be removed.

Embodiments 500 and 600 may be used to replace executable elements that are in an executing control flow graph. As illustrated in embodiments 200 and 300, a new element may be added using embodiment 500, then a second element may be removed using embodiment 600. By replacing executable elements that are in an executing control flow graph, updates, upgrades, and other changes may be implemented without stopping the computer system.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
at least one processor;
an execution environment executing on said at least one processor;
said execution environment that:
receives a control flow graph, said control flow graph comprising executable elements and relationships between said executable elements;
identifies a first executable element in said control flow graph having all dependencies fulfilled and causes said first executable element to be executed;
identifies a second executable element dependent on said first executable element and places said second executable element in a queue for execution after said first executable elements has completed.

2. The system of claim 1, said executable elements being operating system components.

3. The system of claim 2, said operating system components being updated by replacing said second executable element with a third executable element.

4. The system of claim 3, said replacing comprising:
adding said third executable element to said control flow graph;
identifying a first relationship between said first executable element and said second executable element;
establishing a second relationship between said first executable element and said third executable element; and
removing said first relationship.

5. The system of claim 4, said replacing further comprising:
removing said second executable element.

6. The system of claim 5, said replacing further comprising:
analyzing said control flow graph to determine that said second executable element cannot be accessed.

7. The system of claim 1, said operating system that further:
receives an application to execute, said application comprising a plurality of application executable elements;
adds said plurality of application executable elements to said control flow graph; and
identifies a starting execution element within said application executable elements to begin executing said application; and
causes said starting execution element to begin processing said application.

8. The system of claim 1, said execution environment that further:
receives an input;
traverses said control flow graph to identify a third executable element dependent on said input;
determines that said third executable element is ready for execution and causes said third executable element to be executed.

9. The system of claim 8, said input being an input received from a network interface.

10. The system of claim 8, said input being an input received from an executable element.

11. The system of claim 1, said execution environment being incorporated into an operating system.

12. The system of claim 1, said execution environment being separate from an operating system.

13. A method for managing a computer operating system, said method being executed by a computer processor, said method comprising:
receiving a control flow graph, said control flow graph comprising executable elements and relationships between said executable elements, said executable elements comprising operating system functions;
identifying a first executable element in said control flow graph having all dependencies fulfilled and causing said first executable element to be executed;
receiving an input;
traversing said control flow graph to identify a third executable element dependent on said input;
determining that said third executable element is ready for execution and causing said third executable element to be executed.

14. The method of claim 13 further comprising:
receiving an application to execute, said application comprising a plurality of application executable elements;
adding said plurality of application executable elements to said control flow graph; and
identifying a starting execution element within said application executable elements to begin executing said application; and
causing said starting execution element to begin processing said application.

15. The method of claim 14 further comprising:
adding a relationship to said starting execution element within said control flow graph.

16. The method of claim 15 further comprising:
determining that all dependencies for said starting execution element have been fulfilled.

17. The method of claim 16 further comprising:
adding said third executable element to said control flow graph;
identifying a first relationship between said first executable element and said second executable element;
establishing a second relationship between said first executable element and said third executable element; and
removing said first relationship.

18. A system comprising:
at least one processor;
an operating system executing on said at least one processor;
said operating system having a control flow graph scheduler that:
receives a system control flow graph, said system control flow graph comprising executable elements and relationships between said executable elements;
identifies a first executable element in said system control flow graph having all dependencies fulfilled and causes said first executable element to be executed;
identifies a second executable element dependent on said first executable element and places said second executable element in a queue for execution after said first executable elements has completed;
said operating system having a control flow graph manager that:
receives an application control flow graph comprising application executable elements; and
add at least one relationship between said application executable elements and said executable elements in said system control flow graph.

19. The system of claim 18, said control flow graph manager that further:
identifies a first element to remove from said system control flow graph;
removes an upstream relationship to said first element;
removes a downstream relationship to said first element; and
removes said first element from said system control flow graph.

20. The system of claim 19, said downstream relationship being removed after determining that said first element has finished processing.
